(19) United States
(12) Patent Application Publication
(10) Pub. No.: US 2011/0088630 A1
(43) Pub. Date: Apr. 21, 2011

(54) Cat litter box and method of cleaning same

(75) Inventors: Dean B. Krotts, Hartland, WI (US); Adam M. Kellogg, Oconomowoc, WI (US); Michael S. Kellogg, Oconomowoc, WI (US)

(73) Assignee: Sportpet Designs, Inc.

(21) Appl. No.: 12/924,348

(22) Filed: Sep. 24, 2010

Related U.S. Application Data
(60) Provisional application No. 61/277,387, filed on Sep. 24, 2009.

(51) Int. Cl. A01K 29/00

(52) U.S. Cl. 119/166

(57) ABSTRACT

A litter box for use by house pets, such as cats having structure for mechanical separation of clumped litter and waste material from unsoiled litter and subsequent return of unsoiled litter for later use. The litter box preferably includes a first section for receiving both clean litter and the animal preparing to use the device. The first section is separated from a second section by an upstanding sieve or sifting member. The apparatus further includes a removable collection tray for receiving waste material for final disposition after separation. A method of cleaning steps which include lateral rotation and counter-rotation of the device is also disclosed.

### RELATED APPLICATIONS

This case claims the benefit of U.S. provisional patent application Ser. No. 61/277,387, filed 24 Sep. 2009.

### BACKGROUND OF THE INVENTION

Certain types of house pets, such as cats, routinely use litter boxes. Consequently, there is a wide variety of litter box designs, styles and features available for the pet owner from which to choose. Known designs include the simple, flat, rectangular pan, commonly made of plastic. This design may come in an array of different depths, sizes and colors, and may, or may not, include a rim to secure plastic litter box liners in place. Another design is the covered or hooded litter box. These litter boxes are similar to the basic pan, but with the addition of a hood to partly cover the box. An opening may be provided at one end or side of the box to serve as ingress and egress for the animal. Both of these designs require the pet owner to periodically remove waste material from the box. This is an unpleasant task. Therefore, other variants of the litter box have been developed to make this task less unpleasant or even automated.

For example, a sifting box consists of two nested rectangular pans and a tray which acts as a sifter. Self-cleaning boxes have also been developed. Typically, these boxes are powered by electricity and include a sensor to activate a self-cleaning apparatus a few minutes after the animal has left the box. The cleaning apparatus typically includes a rake which rakes through the litter to scoop out waste material into a waste receptacle. While these boxes may be convenient for the pet owner, and lessen the unpleasantness of the cleaning procedure, the devices are typically costly. Furthermore, animals may be startled by the mechanical action if in the vicinity during cleaning. This may cause the animal to avoid using the unit.

Each of the known designs has its advantages and shortcomings. Mainly, cost goes up as convenience in cleaning improves, with the basic uncovered, rectangular box being the least expensive, and automated cleaning units being the most costly. Therefore, there is a need for a cost-effective litter box that is both convenient for the pet owner to clean and appealing to the animal to use.

The present invention, in its disclosed embodiments, strives to provide a cost-effective litter box that provides the easy cleaning advantages of more costly units.

### SUMMARY OF THE INVENTION

The present invention pertains to a litter box for use by house pets, such as cats. The device utilizes clumping litter. Clumping litter is a variety of litter that forms clumps or solid structures when an animal urinates or defecates in the litter. Clumping litter is widely commercially available and commonly sold in pet stores, grocery stores and discount retailers. The apparatus includes means and structure for mechanical separation of clumped litter and waste material from unused or unsoiled litter and subsequent return of unsoiled litter for later use.

A litter box apparatus according to the present invention preferably includes a first section for receiving both clean litter and the animal preparing to use the device. The first section may be uncovered or covered, but if covered, includes access for the animal to use the box. The first section is separated from a second section by an upstanding sieve or sifting member. The sieve or sifting member extends from a bottom side of the litter box toward its upper side. The sieve or sifting member may be formed or molded of any acceptable material that is able to effectively allow clean or unused litter material to flow through its apertures while separating and retaining animal waste and clumped litter material on the opposite side. The apparatus further includes removable collection means, such as a slidable tray or drawer, for receiving screened waste material for final disposition after the separation step is completed, as will hereinafter be discussed.

The invention further contemplates a method of cleaning steps which include lateral rotation and counter-rotation of the device, which must be effected to cause separation of the various particulate matter. The rotation may be achieved by hand. Rotation causes both unsoiled litter and clumped waste material to move toward the sieve or sifting member, thereby separating the clumped waste material from the unsoiled litter, while the unsoiled litter moves through the aperture grates of the sieve to the second section with clumped waste being retained by the sieve or sifting member. The clumped waste material moves over an upper edge of the sieve and into a covered portion of the second section. Subsequent counter-rotation of the device moves the waste material into the removable collection drawer or tray, with unused litter passing back through the sieve or sifting member and into the first section. The collection drawer, or tray, may then be removed and its contents discarded in a separate waste receptacle.

A litter box, according to the present invention, may further include a stationary stand member comprising laterally opposed pivot support members, each upwardly terminating in an open-ended yoke portion arranged for rotative support of laterally opposed pivot members formed on the litter box, which is also preferably made removable to assist in a sequence of rotative positions or steps defining a preferred method of filling, maintaining, and cleaning operations.

The method preferably includes the steps of providing a container or litter box having a first open animal support section and a second partially hooded section; said sections are separated and partitioned by means of a sieve or sifting member to provide a first section and a second section. The sieve extends upwardly from the bottom of the container or litter box and divides the adjacent sections from one another. The upstanding partition also supports a stationary ledge permitting the second section to include a removable waste collection receptacle or tray. The method further includes the steps of placing unused litter in the first section; introducing an animal within the first section; subsequent to the litter being soiled by the animal, rotating the pivotally supported litter box in a direction to cause the litter to be moved through the sieve or sifting member, and into the second section, the screen member retaining the larger, soiled particles and preventing their access to the second section; continuing rotation of the container or litter box, such that the soiled particles, or waste, and preventing their access to the second section; continuing rotation of the container or litter box such that the soiled particles move over the top of the sieve or sifting member, and into the removable waste collection receptacle or tray; counter-rotating the litter box or container so as to direct the screened litter in the second section, back into the first section; and removing the waste collection receptacle or tray, and emptying the waste material there from.

### BRIEF DESCRIPTION OF THE DRAWINGS

FIG. 1 is a perspective view of one embodiment of the present invention, and showing an optional stationary stand with laterally opposed stationary pivot support members pivotally supporting a two-section litter box.

FIG. 2 is an exploded perspective view, similar to that of FIG. 1.

FIG. 3A is a cross-sectional view taken along line 3-3 in FIG. 1 and showing the device ready for cleaning.

FIG. 3B is a cross-sectional view similar to that illustrated in FIG. 3A, and showing the device rotated in the direction of arrow A.

FIG. 3C is a cross-sectional view similar to that illustrated in FIG. 3B, and showing the device further rotated in the direction of arrow A.

FIG. 3D is a cross-sectional view similar to that illustrated in FIG. 3C, and showing the device rotated in the direction of arrow B, opposite of the direction of arrow A.

FIG. 3E is a cross-sectional view similar to that illustrated in FIG. 3D, and showing the device further rotated in the direction of arrow C.

FIG. 3F is a cross-sectional view similar to that illustrated in FIG. 3E, and showing the device rotated in the direction of arrow F.

FIG. 4 is a perspective view of a second embodiment of the present invention, and showing an optional stationary stand with laterally opposed stationary pivot support members pivotally supporting a two-section litter box.

FIG. 5 is a perspective view, similar to that of FIG. 4, and showing an animal positioned in phantom in the aforementioned first, or open, section of the litter box.

FIG. 6 is a perspective view similar to the view of FIG. 4, showing an alternative embodiment adapted for use without a stationary support stand but positioned or supported in a horizontal plane, such as a floor or table top and further, showing the device ready for use.

FIG. 7 is a perspective view, similar to that of FIGS. 4 and 6, but showing an alternative embodiment adapted for use with an alternative stationary support stand.

FIG. 8 is a cross-sectional view of a device similar to that illustrated in FIG. 4 shown pivotally supported on a stationary support stand, taken along line 8-8 thereof.

FIG. 9 is a cross-sectional view of a device similar to that illustrated in FIG. 6, taken along line 9-9 thereof.

FIG. 10 is a cross-sectional view of the device similar to that illustrated in FIG. 7 and taken along line 10-10 thereof.

FIG. 11A is a cross-sectional view similar to the perspective view illustrated in FIG. 4 and showing the device ready for cleaning.

FIG. 11B is a cross-sectional view similar to that illustrated in FIG. 11A, and showing the device rotated in the direction of arrow A.

FIG. 11C is a cross-sectional view similar to that illustrated in FIG. 11B, and showing the device further rotated in the direction of arrow A.

FIG. 11D is a cross-sectional view similar to that illustrated in FIG. 11C, and showing the device rotated in the direction of arrow B, opposite of the direction of arrow A.

FIG. 11E is a cross-sectional view similar to that illustrated in FIG. 11D, and showing the device further rotated in the direction of arrow C.

FIG. 11F is a cross-sectional view similar to that illustrated in FIG. 11E, and showing the device rotated in the direction of arrow F.

FIGS. 12A-12F are a series of cross-sectional views of the litter box, comparable to the respective views of FIGS. 11A-11F, inclusive, but with the exterior bottom surface resting upon a horizontal surface, such as a floor or table top.

FIG. 13A-13F are a series of cross-sectional views of the litter box, comparable to the views of FIGS. 11A-11F, inclusive, but with an alternative stationary support stand.

FIG. 14A is a perspective view of an embodiment and showing removal of the waste material drawer or tray.

FIG. 14B is a perspective view of an embodiment and showing emptying of the drawer or tray.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been generally described, the details of which and the method of use thereof may be changed without departing from the invention.

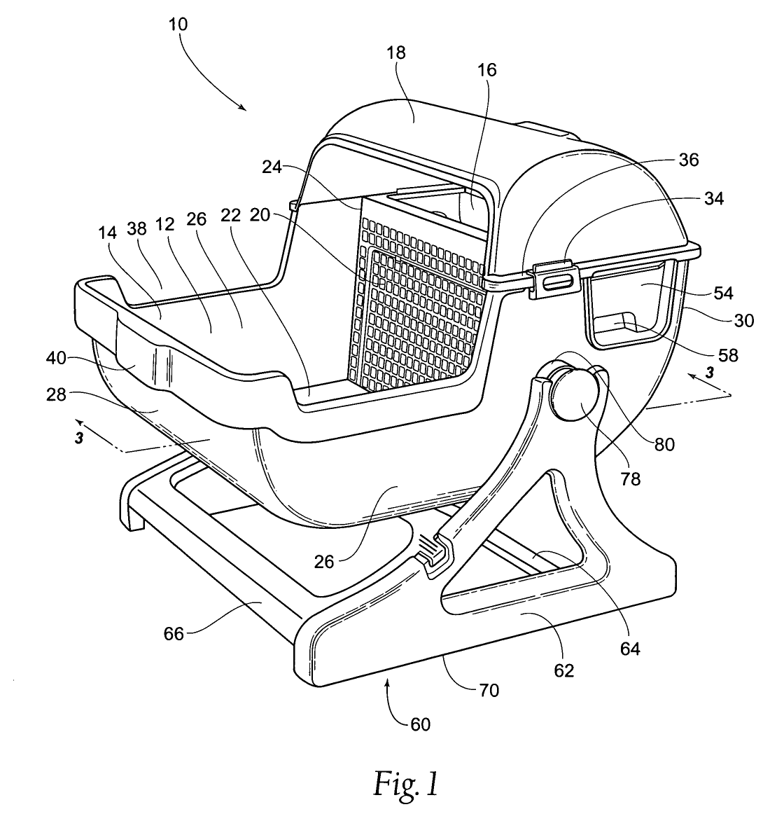

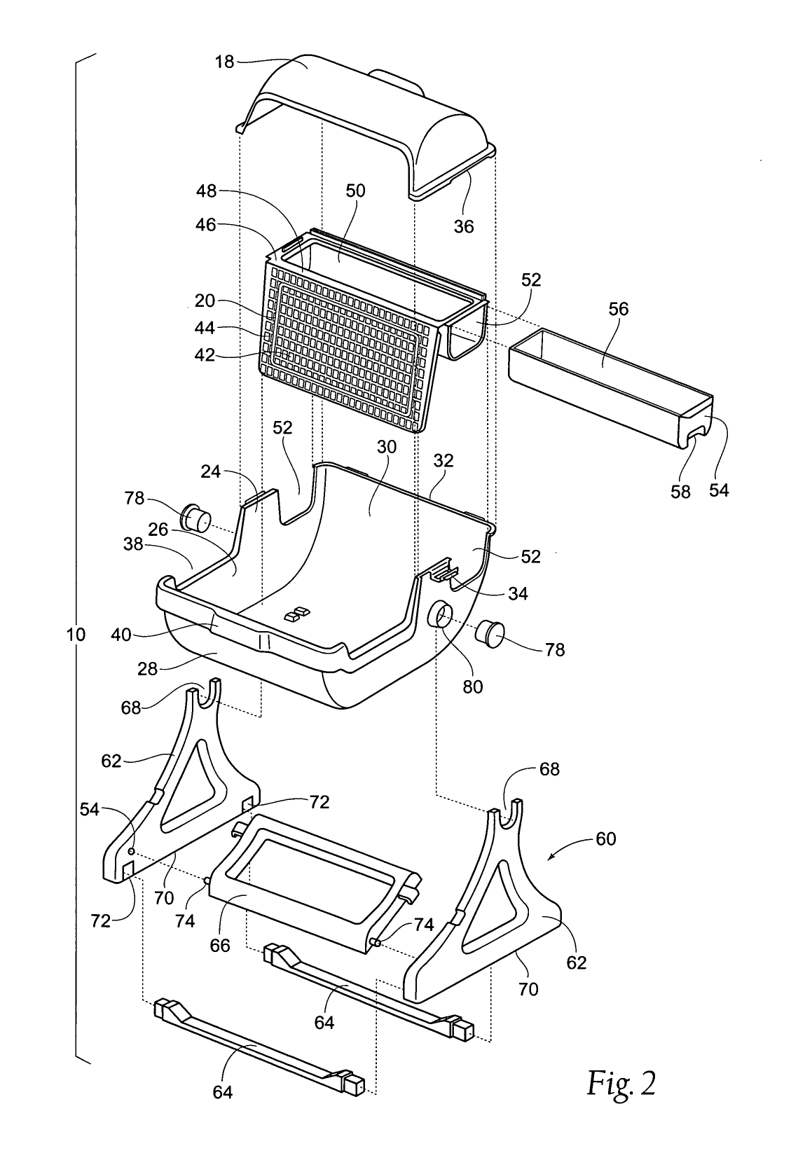

As may be viewed in the aforementioned Figures, each includes an embodiment of the novel litter box 10 and/or its method of cleaning. A preferred version of the novel litter box 10 may be viewed in FIGS. 1 and 2. The stationary stand 70 depicted is optional and not required to practice the invention 10. A rectangular container 12 has a first section 14 and a second section 16. First section 14 is uncovered and the second section 16 is covered. As best shown in FIG. 2, a cover over the second section 16 may be removable. The purpose of the cover being removable is to aid in the cleaning of the litter box 10. The first section 14 and the second section 16 of the container 12 may be molded as a unit, the first section 14 providing access for an animal to use the litter box 10. The first section 14 is separated from the second section 16 by an upstanding sieve or sifting member 20. As illustrated in FIGS. 1, 2, and 3A-F, the sieve or sifting member 20 extends from the bottom side 22 of the litter box 10 upwardly towards the upper marginal area 24 intersecting with each of the side walls 26. The sieve or sifting member 20 may be formed of any acceptable material that is able to effectively receive and retain waste material 92 while allowing unused or unsoiled litter 90 to flow through. Further, the sifting member 20 may be generally flat or of a curved shape to assist in retaining waste material 92 during rotation of the litter box 10 as will hereinafter be described. The apparatus 10 further includes a removable collection means, such as a removable drawer or tray 54. The tray 54 receives screened waste material 92 for final disposition after the separation step is completed, as will be later discussed.

Rectangular container 12 is formed from bottom side 22, a pair of opposed side walls 26, a front wall 28, a rear wall 30 and a cover 18. The front wall 28 and rear wall 30 are preferably arcuate in shape so that the container can be easily laterally rotated and counter-rotate on these arcuate surfaces as will be further described herein. The cover 18 may or may not be removable from the container 12. In the embodiment shown in FIGS. 1 and 2, the cover 18 is removable. As best shown in FIG. 2, when placed over an upper edge 32 of the container 12, the removable cover 18 is held in place by a pair of opposed latches 34. In the preferred embodiment, the latches 34 are attached to the side walls 26 and engage with a protruding edge 36 about the periphery of the removable cover 18.

Rectangular container 12 also preferably has a recess 38 formed in at least one side wall 26 to allow easy ingress and egress of the animal into and out of the litter box 10. A handle or other gripping structure 40 is formed in or along the upper edge of the front wall to aid the user in cleaning the litter box, as will be described herein.

Again as best shown in FIG. 2, a portion 42 of the sieve or sifting screen 20 may be detachable from a sieve or sifting screen frame 44. This allows the user to easily clean the detachable portion 44 without the necessity of disassembling the entire litter box apparatus 10. An upper edge 46 of the sieve or sifting member 20 meets with the leading edge 48 of the waste receptacle housing 50. The housing 50 fits and is supported within the container 12 by way of recesses 52 formed in the container 12 side walls 26. In the embodiment shown in FIGS. 1 and 2, the housing 50 is retained by the cover 18 and is also secured with the latches 34. An opening 52 is formed in the housing 50 to receive a removable drawer or tray 54. The tray 54 includes a cavity 56 formed therein for receiving the waste material 92 when the litter box 10 is cleaned. The tray further includes a handle or gripping structure 58 allowing the user to easily grasp, remove and replace the tray as needed. It will be further appreciated that the opening 52 can be formed on the opposite side of the waste receptacle housing 50 to allow the user the option of removing the waste receptacle or tray 54 from the opposite side of the litter box 10.

As may be seen in the views of FIGS. 1 and 2, for example, an apparatus 10 according to the present invention may further include a stationary support stand member 60 to assist the user in the required rotation steps. The litter box 10 is shown to be supported on a stand 60 that may include a pair of opposed stationary support members or braces 62 and a pair of cross members 64. The support members or braces 62, in conjunction with the pivotal support member 66 are formed with a preferred configuration and connecting fittings arranged to provide level support of the litter box 10 during use, and pivotable support during cleaning. Each stationary support member 62 includes a semi-circular recess or yoke 68 formed at its uppermost portion and a relatively flat base portion 70 along its lowermost portion. The respective ends of each pair of cross members 64 are received in openings 72 formed in the stationary members 62 adjacent their base portions. Pivotal support member 66 includes a pair of pivot pins 74 that are received in openings 76 also formed in stationary support members 62.

A pair of receptacles 80 is formed in each side wall 26 to pivotally support the litter box 10 on the stationary stand 60. A pair of removable pins 78 fits within receptacles 80 and restrict lateral movement of the litter box 10 relative to the stand 60 and thereby retain the litter box 10 within the semicircular recesses 68 during rotation and counter-rotation of the litter box 10. As will be discussed herein, pivotal support member 66, in conjunction with stationary support members 62, supports the litter box 10 in a generally level configuration when in use and allows the litter box 10 to be counter-rotated past the level position to evenly distribute unsoiled litter in the litter box 10 after cleaning.

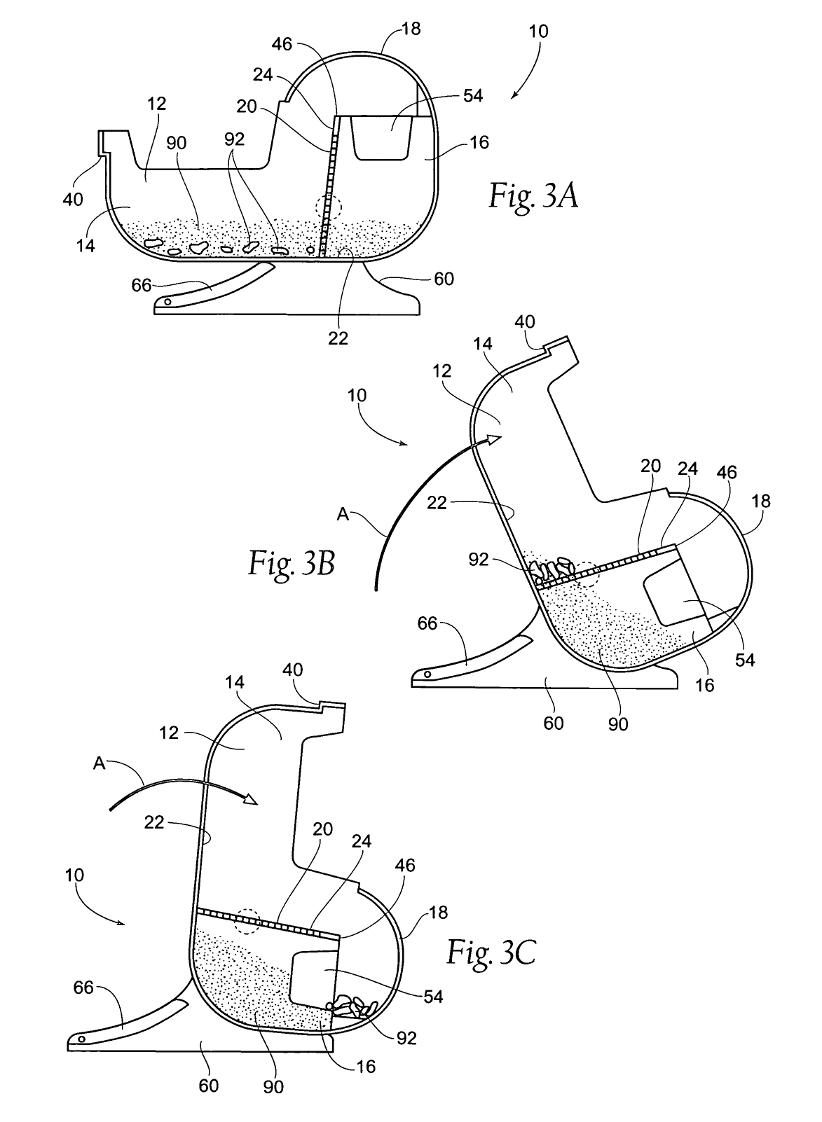

Steps for cleaning the litter box apparatus 10 may be viewed particularly in FIGS. 3A-3F. As shown in FIG. 3A, the litter box 10 is resting upon a stationary stand 60 and lateral rotation and counter-rotation of the device 10 must be effected to cause separation of the various particulate matters 90 and 92. As seen in the view of FIG. 3B, rotation of the apparatus 10 in the direction of arrow A thereby separates the clumped waste material 92 from the unsoiled litter material 90 as both unsoiled litter 90 and clumped waste material 92 move toward the side of sieve or sifting member 20 that faces the first section 14. Continued rotation of the litter box 10, again in the direction of arrow A and as shown in FIG. 3C, permits unsoiled litter 90 to continue to move through the apertures of the sieve or shifting member 20 and into the second section 16. As is also viewed in FIG. 3C and as the litter box 10 is further rotated in the direction of arrow A to thereby separate the clumped waste material 92 from the unsoiled litter material 90, the clumped waste material 92 passes over the upper edge 46 of the sieve 20 and now rests upon the inside surface of the cover 18. As shown in FIG. 3D when the litter box 10 is next counter-rotated in the direction of arrow B, the clumped waste material 92 falls into the cavity 56 of waste removal tray or drawer 54. As counter-rotation continues, again in the direction of arrow B, unsoiled litter 90 passes through the sieve or sifting member 20 in the opposite direction (e.g. from the second section 16 to the first section 14). At the same time, the clumped waste material 92 is still retained in cavity 56 of tray 54.

When the litter box 10 reaches its initial generally level position (as originally shown in FIG. 3A), not substantially all of the unsoiled litter 90 will have been returned to first section 14. An abundant portion of unsoiled litter may remain in the second portion 16 on the opposite side of the sieve or sifting member 20. To aid in even and easy redistribution of the unsoiled litter 90 in the litter box 10, pivotal support member 66 is moved in the direction of arrow D shown in FIG. 3E thereby allowing the litter box 10 to tilt forward whereby a greater portion of the unsoiled litter 90 is returned to the first section 14. Next and as shown in FIG. 3F, the litter box 10 may be rotated in the direction of arrow F and the pivotal support member is rotated in the direction of arrow E until it is returned to its original position and the litter box 10 rests in a substantially level position on stationary stand 60.

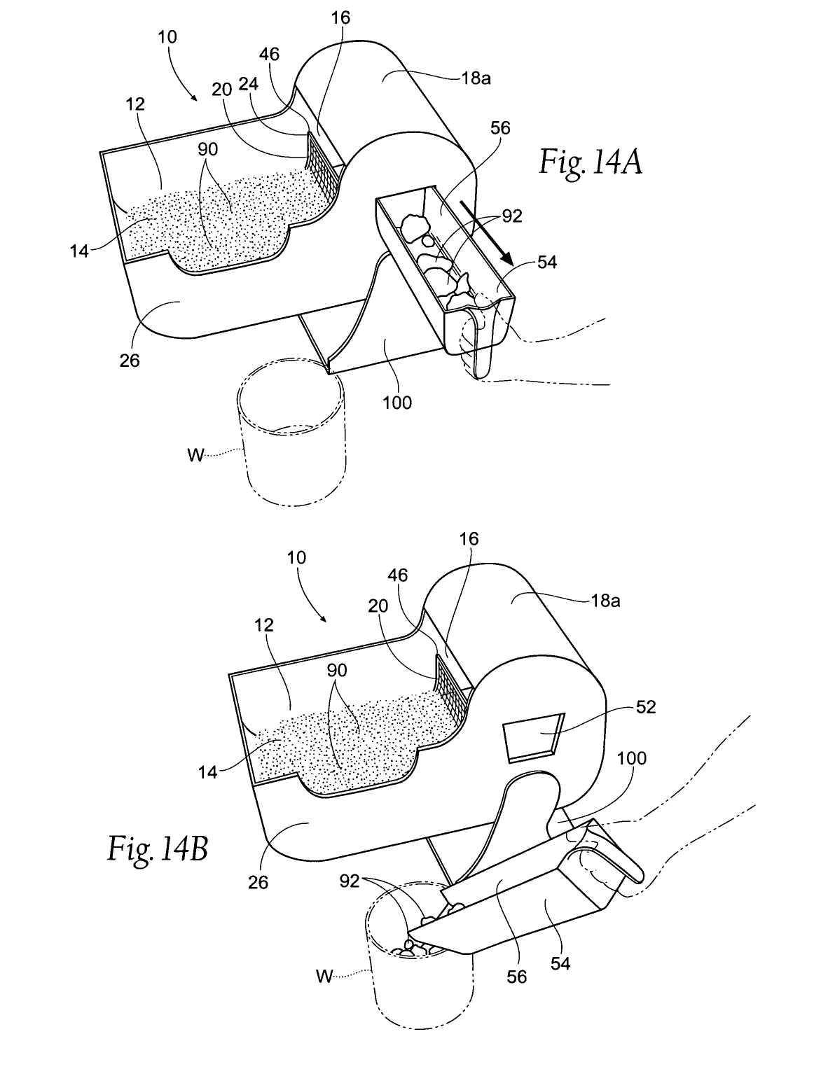

Referring now to FIGS. 14A and 14B, after each rotation and counter-rotation of the litter box 10 or when desired by the user, the removable drawer or tray 54 may be withdrawn from its housing 50 and the contents 92 emptied into a waste container (shown in phantom in FIGS. 14A and 14B).

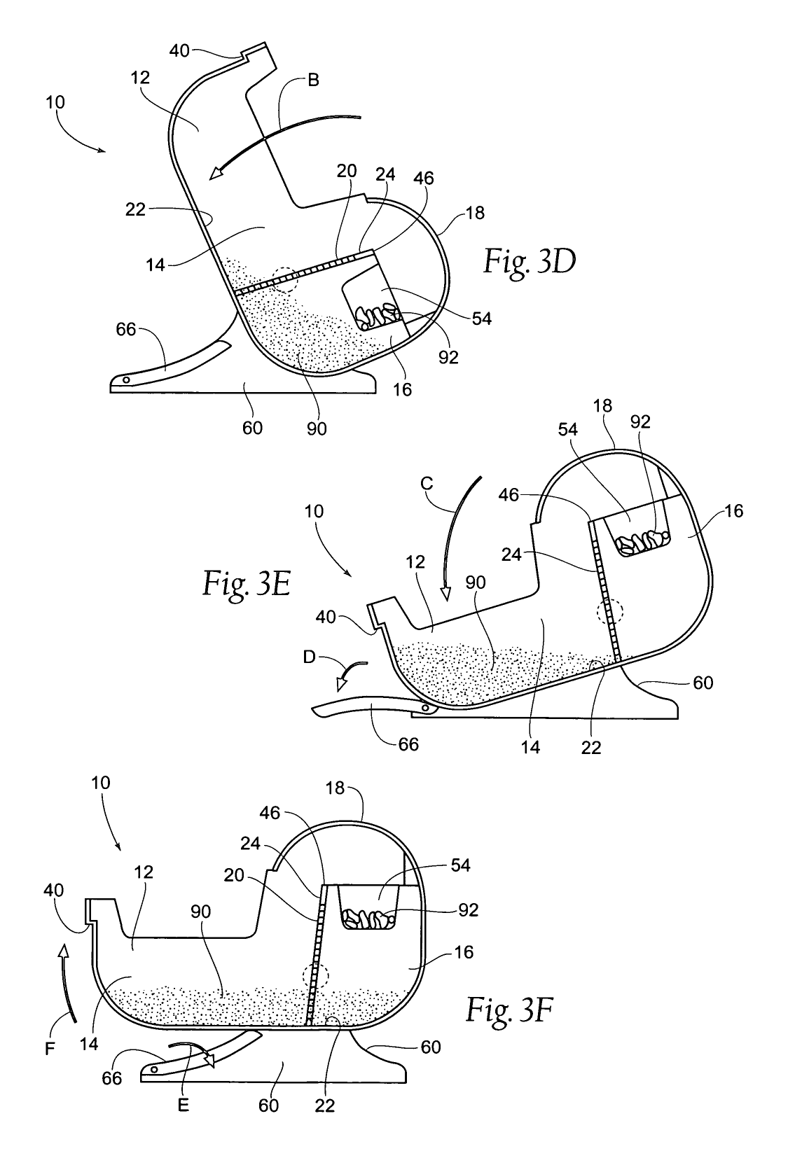

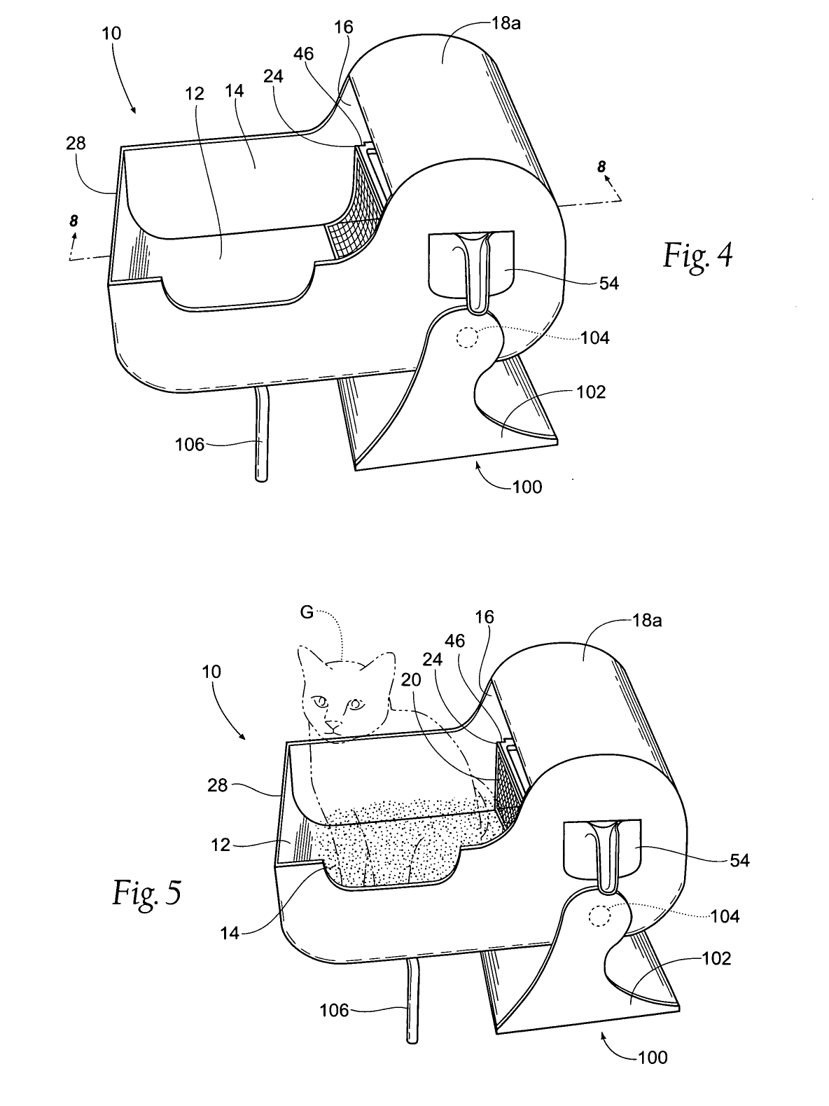

An alternative embodiment of the litter box 10 is shown in FIGS. 4, 5, 8 and 11A-11F. The structure of the litter box 10 is substantially the same including a rectangular container 12 having a first section 14 and a second section 16. The container is formed from bottom side 22, opposed side walls 26, a front wall 28 and a rear wall 30. In this embodiment, the cover 18a is integrally formed with the container 12. The sieve or sifting member 20 extends between the bottom side 22 and extends upwardly to the upper marginal area 24. The upper edge 46 of the sieve 20 abuts the waste receptacle housing 50. The alternate embodiment also includes a stationary stand 100 having an integrally formed base having opposed stationary support members or braces 102. The support members 102 pivotally attach to the litter box 10 and connection 104. A pivotal leg 106 is attached to bottom side 22 to hold the litter box 10 in a substantially level position during use by a cat (see FIG. 5, reference letter G). The pivotal leg 106 also allows the front side 28 of the litter box to be lowered after counter-rotation so that the unsoiled litter 90 may be evenly distributed within the litter box 10 as previously described.

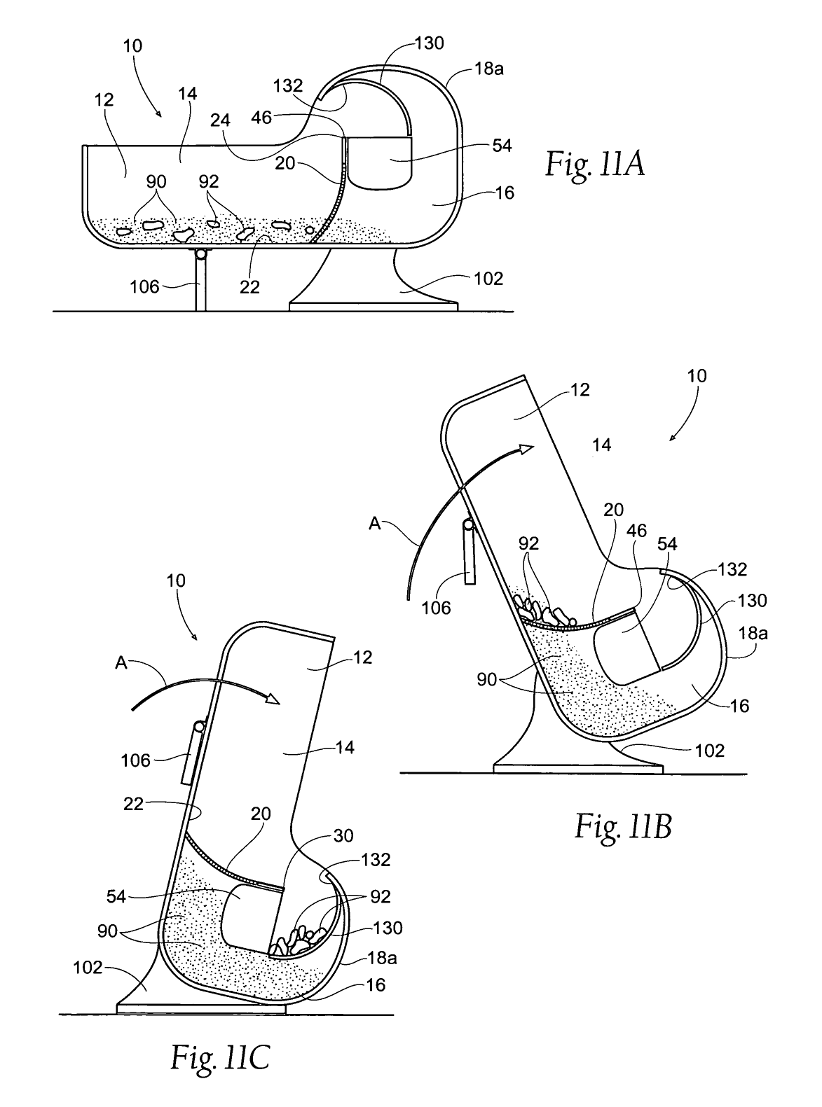

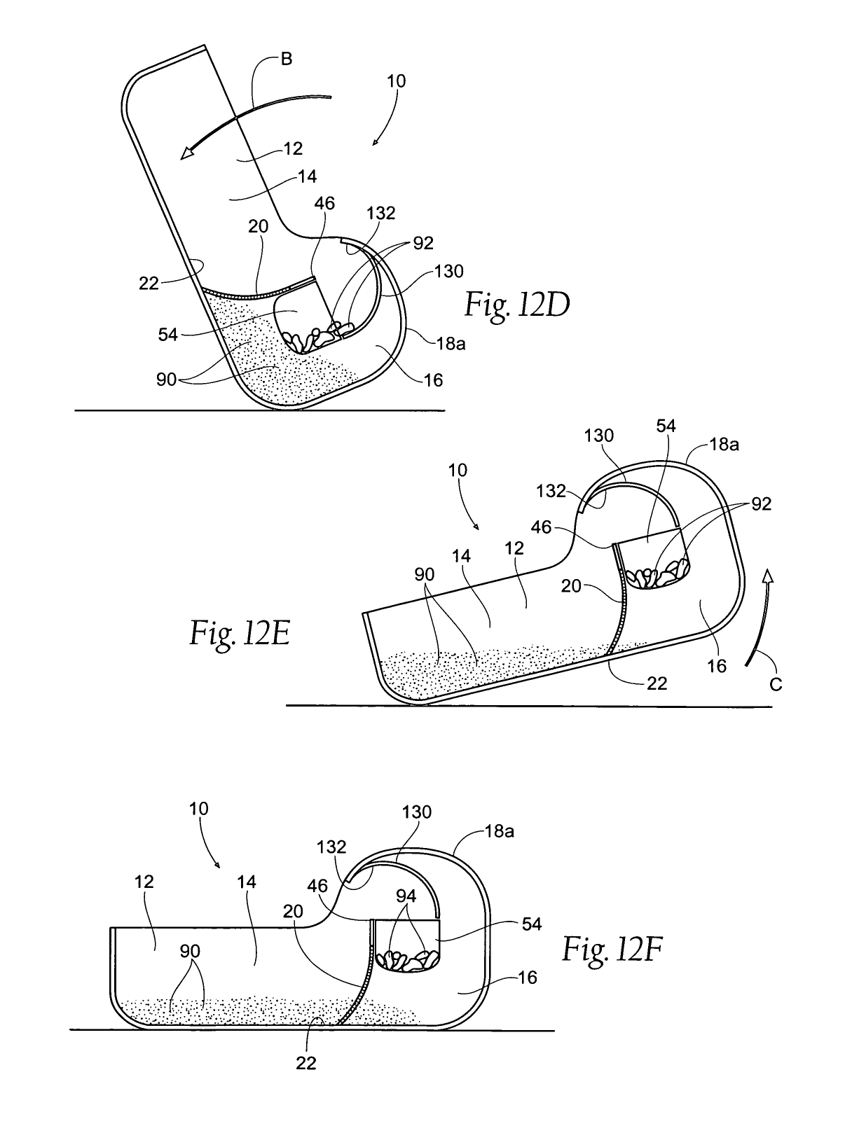

Referring specifically to FIG. 8, this embodiment includes a baffle 130 located between integral cover 18a and the waste receptacle 54. The baffle 130 meets the cover 18a at junction 132. As can best be seen in FIGS. 11B and 11C, the baffle 130 prevents unsoiled litter 92 from passing into the waste receptacle 54 during rotation of the litter box 10.

Steps for cleaning this alternate embodiment of litter box apparatus 10 may be viewed in FIGS. 11A-11F. As shown in FIG. 11A, both the unsoiled litter 90 and the waste material 92 initially rest on the bottom floor 22 in a starting horizontal position of the unit 10. The litter box 10 is resting upon stationary stand 100 and lateral rotation and counter-rotation of the device 10 must be effected to cause separation of the various particulate matters 90 and 92. As seen in the view of FIG. 11B, rotation of the apparatus 10 in the direction of arrow A thereby separates the clumped waste material 92 from the unsoiled litter material 90 as both unsoiled litter 90 and clumped waste material 92 move toward the side of sieve or sifting member 20 that faces the first section 14. Continued rotation of the litter box 10, again in the direction of arrow A and as shown in FIG. 11C, permits unsoiled litter 90 to continue to move through the apertures of the sieve or shifting member 20 and into the second section 16. As is also viewed in FIG. 11C and as the litter box 10 is further rotated in the direction of arrow A to thereby separate the clumped waste material 92 from the unsoiled litter material 90, the clumped waste material 92 passes over the upper edge 46 of the sieve 20 and now rests upon the inside surface of the baffle 130. As shown in FIG. 11D when the litter box 10 is next counter-rotated in the direction of arrow B, the clumped waste material 92 falls into the cavity 56 of waste removal tray or drawer 54. As counter-rotation continues, again in the direction of arrow B, unsoiled litter 90 passes through the sieve or sifting member 20 in the opposite direction (e.g. from the second section 16 to the first section 14). At the same time, the clumped waste material 92 is still retained in cavity 56.

When the litter box 10 reaches its initial generally level position (as originally shown in FIG. 11A), not substantially all of the unsoiled litter 90 will have been returned to first section 14. An abundant portion of unsoiled litter may remain in the second portion 16 on the opposite side of the sieve or sifting member 20. To aid in even and easy redistribution of the unsoiled litter 90 in the litter box 10, pivotal support member 106 is moved in the direction of arrow D shown in FIG. 11E thereby allowing the litter box 10 to tilt forward whereby a greater portion of the unsoiled litter 90 is returned to the first section 14. Next and as shown in FIG. 11F, the litter box 10 may be rotated in the direction of arrow F and the pivotal support member 106 is rotated in the direction of arrow E until it is returned to its original position and the litter box 10 rests in a substantially level position on stand 100.

Referring again now to FIGS. 14A and 14B, after each rotation and counter-rotation of the litter box 10 or when desired by the user, the removable drawer or tray 54 may be withdrawn from its housing 50 and the contents 92 emptied into a waste container (as shown in phantom in FIGS. 14A and 14B).

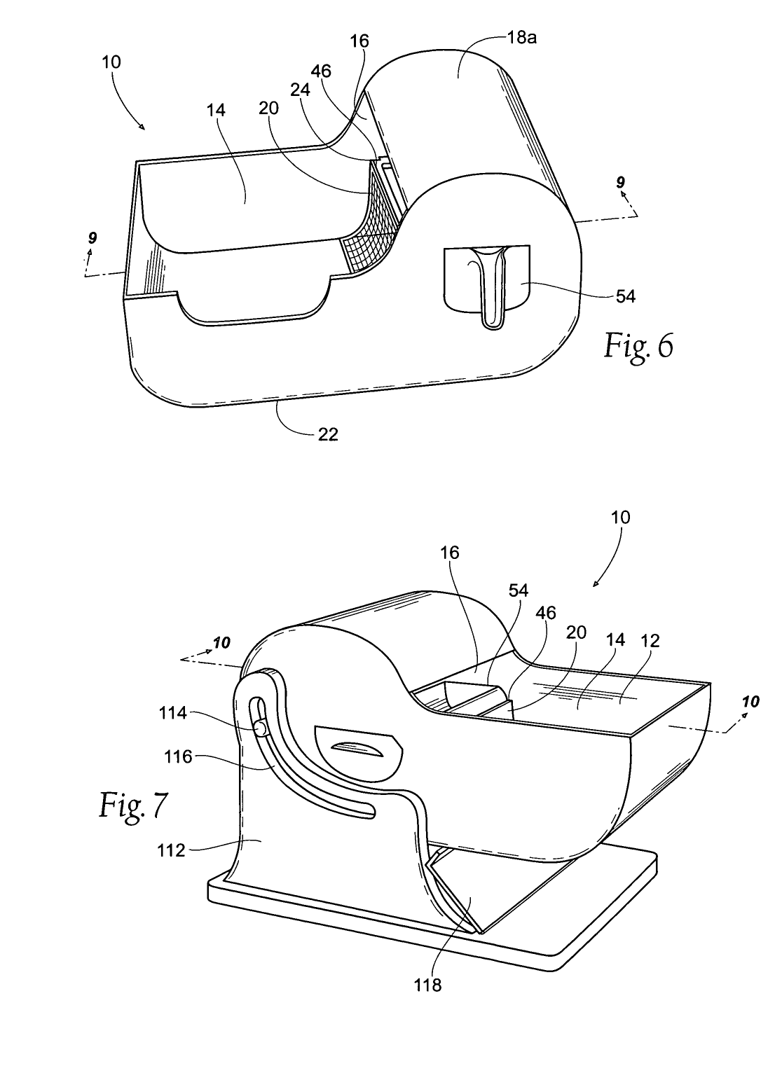

FIGS. 6, 9 and 12A-12F depict the litter box 10 without a stand. In this embodiment, the bottom side 22 rests upon a flat surface, such as a floor, counter or table top. The structure of the litter box 10 is again substantially the same including a rectangular container 12 having a first section 14 and a second section 16. The container 12 is formed from bottom side 22, opposed side walls 26, a front wall 28 and a rear wall 30. The front wall 28 and rear wall 30 are preferably arcuate in shape so that the container can be easily laterally rotated and counter-rotate on these arcuate surfaces as will be further described herein. In this embodiment, the cover 18a is again integrally formed with the container 12. The sieve or sifting member extends between the bottom side 22 and extends upwardly to the upper marginal area 24. The upper edge 46 of the sieve 20 abuts the waste receptacle housing 50.

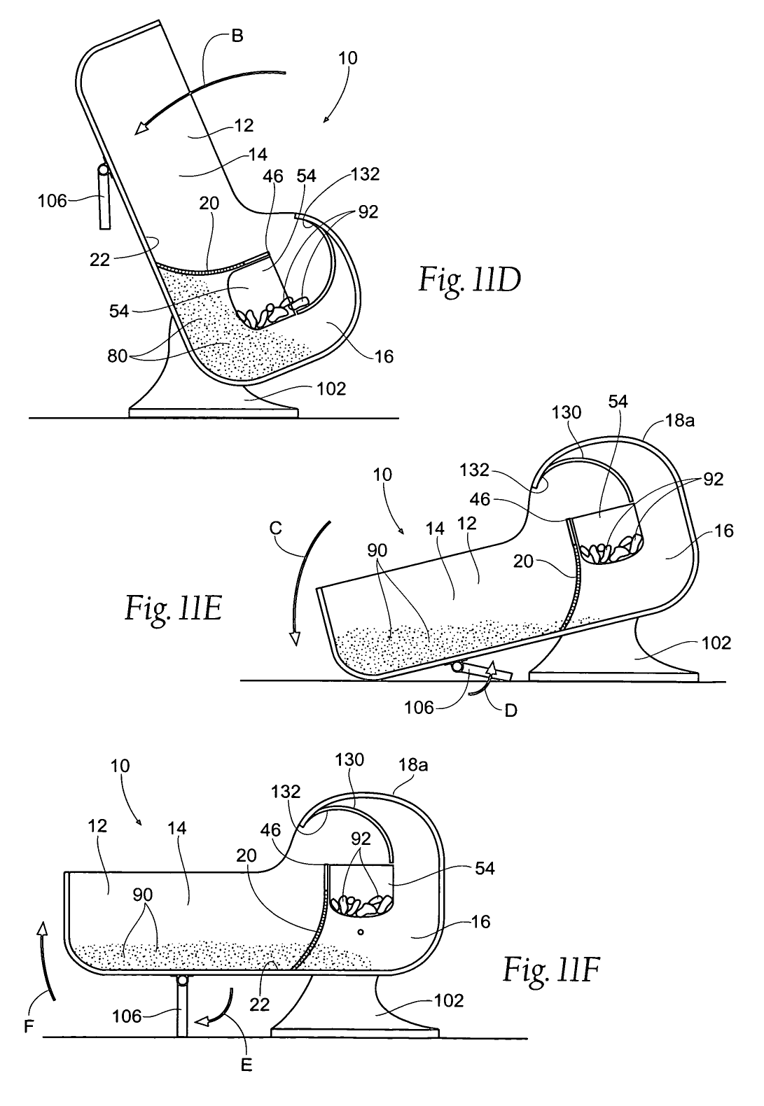

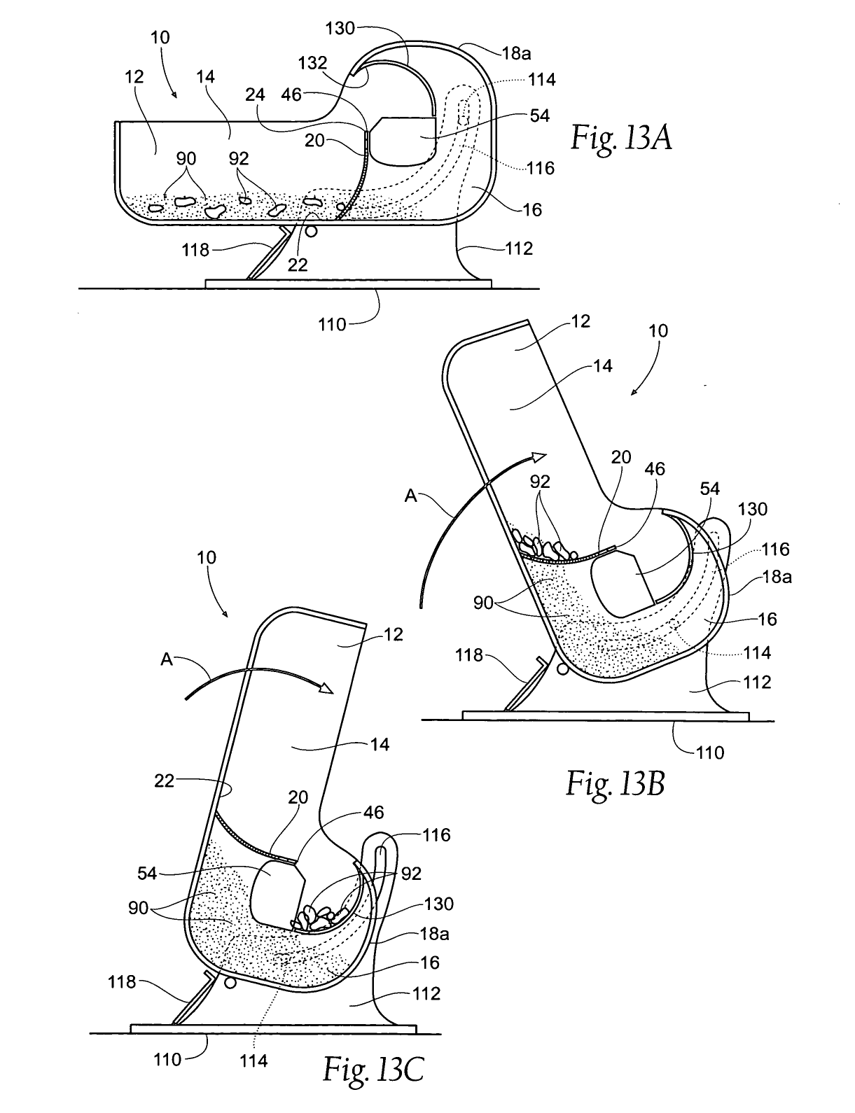

Referring specifically to FIG. 9, this embodiment includes a baffle 130 located between integral cover 18a and the waste receptacle 76. The baffle 130 meets the cover 18a at juncture 132. As can best be seen in FIGS. 12B and 12C, the baffle 130 prevents unsoiled litter from passing into the waste receptacle 76 during rotation of the litter box 10.

Steps for cleaning this alternate embodiment of litter box apparatus 10 may be viewed in FIGS. 12A-12F. As shown in FIG. 12A, the litter box 10 is resting upon a flat surface and lateral rotation and counter-rotation of the device 10 must be effected to cause separation of the various particulate matters 90 and 92. As seen in the view of FIG. 12B, rotation of the apparatus 10 in the direction of arrow A thereby separates the clumped waste material 92 from the unsoiled litter material 90 as both unsoiled litter 90 and clumped waste material 92 move toward the side of sieve or sifting member 20 that faces the first section 14. Continued rotation of the litter box 10, again in the direction of arrow A and as shown in FIG. 12C, permits unsoiled litter 90 to continue to move through the apertures of the sieve or shifting member 20 and into the second section 16. As is also viewed in FIG. 12C and as the litter box 10 is further rotated in the direction of arrow A to thereby separate the clumped waste material 92 from the unsoiled litter material 90, the clumped waste material 92 passes over the upper edge 46 of the sieve 20 and now rests upon the inside surface of the baffle 130. As shown in FIG. 12D when the litter box 10 is next counter-rotated in the direction of arrow B, the clumped waste material 92 falls into the cavity 56 of waste removal tray or drawer 26. As counter-rotation continues, again in the direction of arrow B, unsoiled litter 90 passes through the sieve or sifting member 20 in the opposite direction (e.g. from the second section 16 to the first section 14). At the same time, the clumped waste material 92 is still retained in cavity 56.

When the litter box 10 reaches its initial generally level position (as originally shown in FIG. 12A), not substantially all of the unsoiled litter 90 will have been returned to first section 14. An abundant portion of unsoiled litter may remain in the second portion 16 on the opposite side of the sieve or sifting member 20. To aid in even and easy redistribution of the unsoiled litter 90 in the litter box 10, the back side of the litter box is pivoted upward as shown by arrow C in FIG. 12E thereby allowing the litter box 10 to tilt forward whereby a greater portion of the unsoiled litter 90 is returned to the first section 14. Next and as shown in FIG. 12F, the litter box 10 may be returned to its initial position so that it rests in a substantially level position.

Referring again now to FIGS. 14A and 14B, after each rotation and counter-rotation of the litter box 10 or when desired by the user, the removable drawer or tray 54 may be withdrawn from its housing 50 and the contents 92 emptied into a waste container (as shown in phantom in FIGS. 14A and 14B).

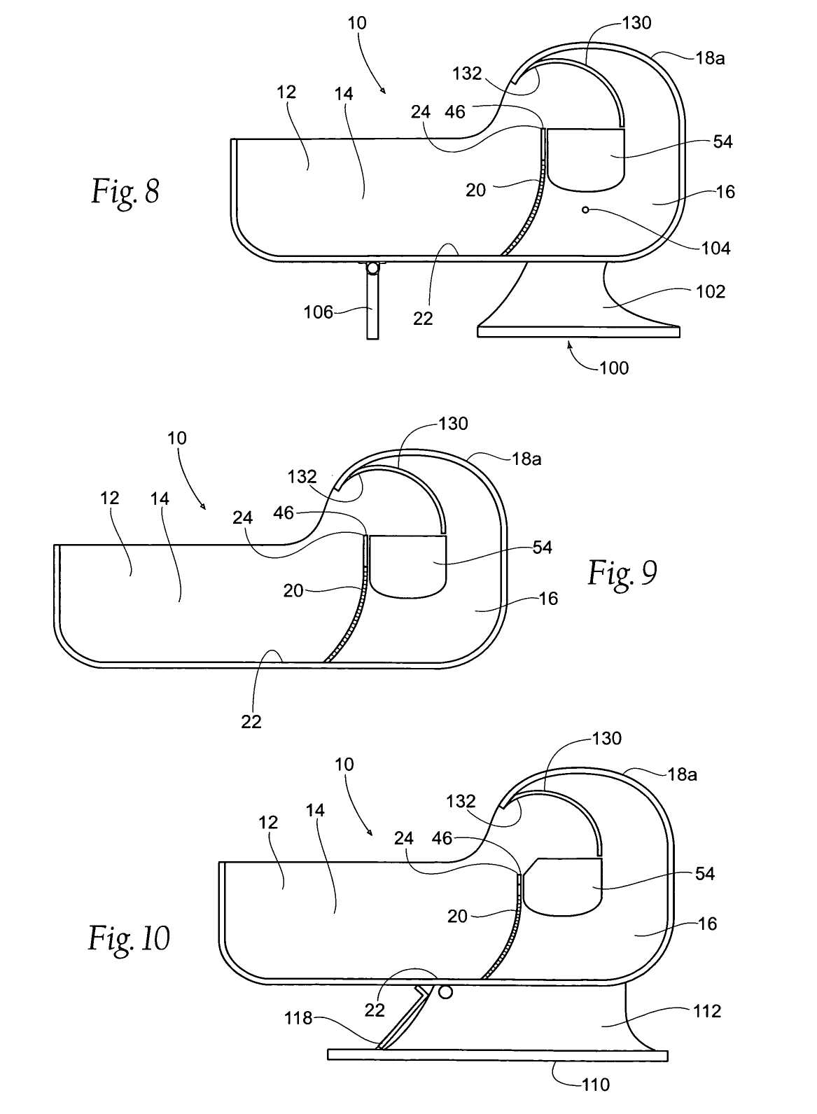

Another alternative embodiment of the litter box 10 is shown in FIGS. 7, 10 and 13A-13F. The structure of the litter box 10 is substantially the same including a rectangular container 12 having a first section 14 and a second section 16. The container 12 is formed from bottom side 22, opposed side walls 26, a front wall 28 and a rear wall 30. In this embodiment the cover 18a is again integrally formed with the container 12. The sieve or sifting member extends between the bottom side 22 and extends upwardly to the upper marginal area 24. The upper edge 46 of the sieve 20 abuts the waste receptacle housing 50. This alternate embodiment also includes a stand 110 having a base including opposed stationary support members or braces 112. The support members or braces 112 each have an elongated curved opening 116 formed therein which each receives a pin attached to the litter box 10.

Each pin 114 rides within each elongated opening 116 allowing the litter box to pivot as hereinafter described. A pivotal plate 118 is attached to upper side of base 110 to hold the litter box in a substantially level position during use (see FIG. 7). The pivotal plate 118 also allows the front side of the litter box 10 to be lowered after counter-rotation so that the unsoiled litter may be evenly distributed within the litter box 10 as described herein.

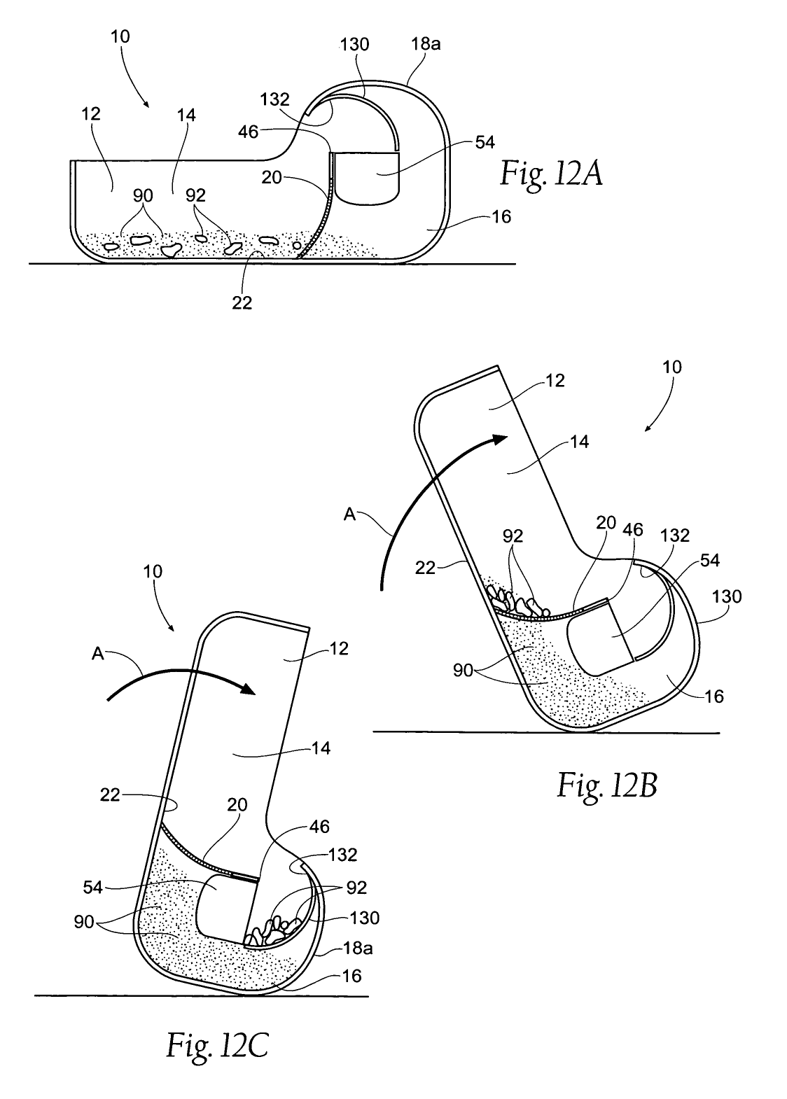

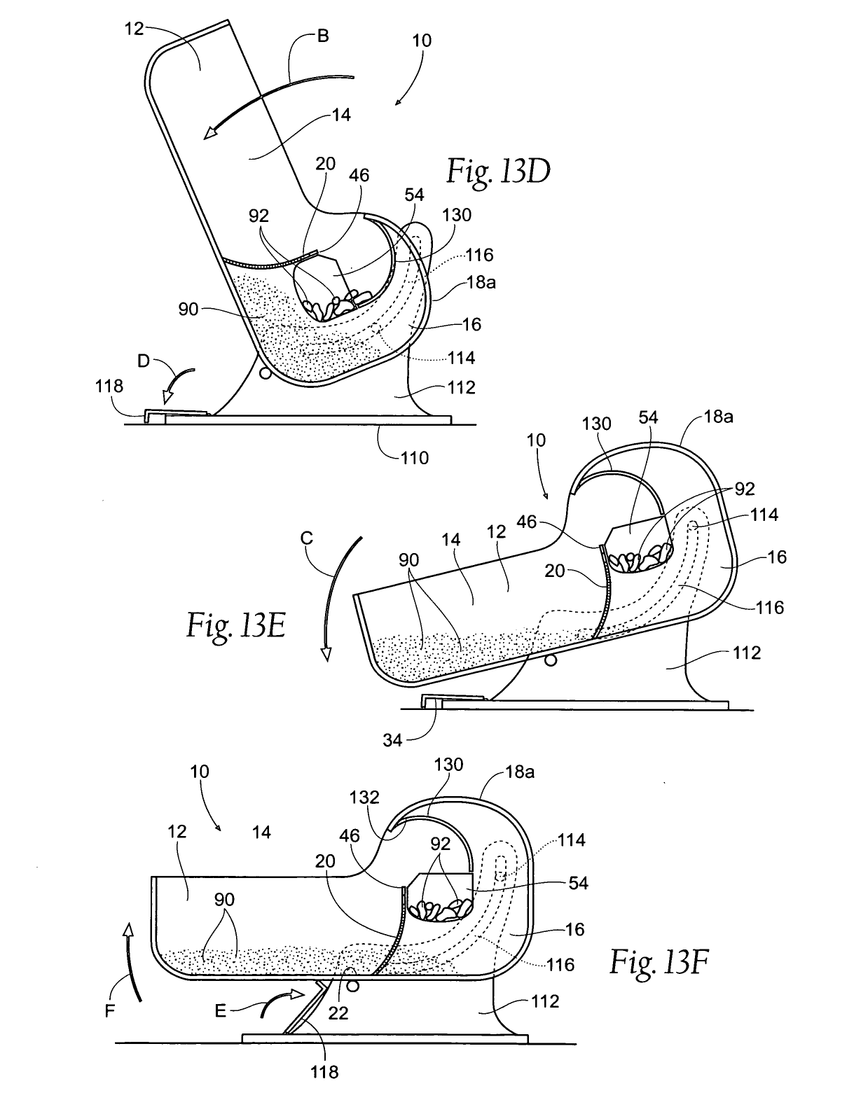

Referring specifically to FIG. 10, this embodiment may also include a baffle 130 located between integral cover 18a and the waste receptacle 76. The babble 130 meets cover 18a at the juncture 132. As can best be seen in FIGS. 13B and 13C, the baffle 130 prevents unsoiled litter from passing into the waste receptacle 76 during rotation of the litter box 10.

Steps for cleaning this alternate embodiment of litter box apparatus 10 may be viewed in FIGS. 13A-13F. As shown in FIG. 13A, the litter box 10 is resting upon a stationary stand 110 and lateral rotation and counter-rotation of the device 10 must be effected to cause separation of the various particulate matters 90 and 92. As seen in the view of FIG. 13B, rotation of the apparatus 10 in the direction of arrow A thereby separates the clumped waste material 92 from the unsoiled litter material 90 as both unsoiled litter 90 and clumped waste material 92 move toward the side of sieve or sifting member 20 that faces the first section 14. Continued rotation of the litter box 10, again in the direction of arrow A and as shown in FIG. 13C, permits unsoiled litter 90 to continue to move through the apertures of the sieve or shifting member 20 and into the second section 16. As is also viewed in FIG. 13C and as the litter box 10 is further rotated in the direction of arrow A to thereby separate the clumped waste material 92 from the unsoiled litter material 90, the clumped waste material 92 passes over the upper edge 46 of the sieve 20 and now rests upon the inside surface of the baffle 130.

As shown in FIG. 13D when the litter box 10 is next counter-rotated in the direction of arrow B, the clumped waste material 92 falls into the cavity 56 of waste removal tray or drawer 26. As counter-rotation continues, again in the direction of arrow B, unsoiled litter 90 passes through the sieve or sifting member 20 in the opposite direction (e.g. from the second section 16 to the first section 14). At the same time, the clumped waste material 92 is still retained in cavity 56.

When the litter box 10 reaches its initial generally level position (as originally shown in FIG. 13A), not substantially all of the unsoiled litter 90 will have been returned to first section 14. An abundant portion of unsoiled litter may remain in the second portion 16 on the opposite side of the sieve or sifting member 20. To aid in even and easy redistribution of the unsoiled litter 90 in the litter box 10, pivotal support plate 118 is moved in the direction of arrow D shown in FIG. 13D thereby allowing the litter box 10 to tilt forward whereby a greater portion of the unsoiled litter 90 is returned to the first section 14 as shown in FIG. 13E. Next and as shown in FIG. 13F, the litter box 10 may be rotated in the direction of arrow F and the pivotal support plate 118 is rotated in the direction of arrow E until it is returned to its original position and the litter box 10 rests in a substantially level position on stand 112.

Referring once again to FIGS. 14A and 14B, after each rotation and counter-rotation of the litter box 10 or when desired by the user, the removable drawer or tray 54 may be withdrawn from its housing 50 and the contents 92 emptied into a waste container (as shown in phantom in FIGS. 14A and 14B).

The invention further contemplates a method of cleaning a litter box 10 comprising the steps of providing a litter box 10 having a first section 14 and a second section 16; providing a sieve or sifting member 20, the sieve member 20 extending from a bottom surface 22 of the litter box 10, said sieve or sifting member 20 dividing the first section 12 from the second section 16; providing the second section 16 with a waste collection drawer or tray 76; placing litter 14 in the first section 12; introducing an animal to the first section 12; subsequent to the litter 14 being soiled by the animal, laterally rotating the litter box 10 in a direction to move the unsoiled litter 90 through the apertures of the sifting member 20 and into the second section 16, the sifting member 20 retaining the waste material 92 on the first side of the sieve 20; continuing rotation of the box 10 such that the waste material 92 moves over the top of the sieve or sifting member 20 and into the longitudinally removable collection drawer 76; counter-rotating the litter box 10 so as to redirect the screened litter 90 from the second section 16 back into the first section 14; removing the waste collection drawer 76; and emptying the waste material 24 there from.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

We claim:

1. An animal litter box apparatus comprising:
a container for receiving an animal;
said container having a bottom, a front wall, a rear wall, and a pair of laterally spaced side walls, adjacent ones of said walls being respectively conjoined with and extending upwardly from said bottom;
said container having an upstanding partition arranged to divide said container into frontal and rearward sections;
said partition including sifting means in the form of an apertured sieve extending from the bottom of said container and upwardly to provide a supporting ledge and an upwardly spaced area between an upper edge of each of the side walls of said container; and
a removable waste collection tray extending between said side walls and transversely across said upstanding partition.

2. The animal liter box of claim 1 wherein the outer surface between the front wall and the bottom defines a first arcuate surface and the outer surface between the bottom and the rear wall defines second arcuate surface.

3. The animal liter box of claim 1 further comprising a cover removably attached to the upper edges of said rear wall and side walls.

4. The animal liter box of claim 1 wherein said partition is removable.

5. The animal litter box of claim 1, wherein the upper edge of at least one of said container side walls includes a relieved area arranged to provide access to a relatively small animal.

6. The animal litter box of claim 1, wherein said outer surface includes longitudinally spaced arcuate areas formed to rotatably support said container while said outer surface is in physical contact with a supporting surface.

7. An animal litter box apparatus according to claim 1, wherein said container is rotatably supported by a pair of laterally spaced, upstanding support members.

8. The animal litter box apparatus of claim 7 wherein said support members comprises a stationary support stand including laterally spaced, upwardly extending braces, each brace having individual upwardly facing supporting yoke members positioned proximate to the upper extremities of each of the respective braces.

9. An animal liter box comprising:
a bottom wall, a front wall, a rear wall and a pair of laterally spaced side wall defining a container;
a removable sifting screen dividing said container into first and second sections;
a cover attached to upper edges of said rear wall and said side walls over said second section; and
a removable waste collection tray supported in said second section between said side walls and adjacent said sifting screen.

10. The animal liter box of claim 9 wherein the outer surface between the front wall and the bottom wall defines a first arcuate surface and the outer surface between the bottom and the rear wall defines second arcuate surface.

11. The animal litter box of claim 9, wherein the upper edge of at least one of said container side walls includes a relieved area arranged to provide access to a relatively small animal.

12. The animal litter box of claim 9, wherein said outer surface includes longitudinally spaced arcuate areas formed to rotatably support said container while said outer surface is in physical contact with a supporting surface.

13. An animal litter box apparatus according to claim 9, wherein said container is rotatably supported by a pair of laterally spaced, upstanding support members.

14. The animal litter box apparatus of claim 13 wherein said support members comprises a stationary support stand including laterally spaced, upwardly extending braces, each brace having individual upwardly facing supporting yoke members positioned proximate to the upper extremities of each of the respective braces.

15. A method of filling, utilizing and cleaning an animal litter box, said method comprising the steps of:
supplying a container having continuous surrounding walls and an upstanding partition intermediate its ends to define front and rear sections, said partition including sifting means in the form of an apertured sieve;
supplying a preselected amount of animal litter to said front section;
supplying a removable waste collection tray extending between said walls and transversely across said upstanding partition;
rotating said container to provide a means for sifting passage of said litter and thereby transferring any clumped litter or waste from said front section to said tray; and
withdrawing said tray for emptying the clumped liter or waste into a conventional waste receptacle.
